(19) United States
(12) Patent Application Publication
(10) Pub. No.: US 2015/0326008 A1
(43) Pub. Date: Nov. 12, 2015

(54) FAULT PROTECTION CIRCUIT

(71) Applicant: Power Integrations, Inc., San Jose, CA (US)

(72) Inventors: Stefan Bäurle, San Jose, CA (US); David Michael Hugh Matthews, Los Gatos, CA (US)

(73) Assignee: Power Integrations, Inc., San Jose, CA (US)

(21) Appl. No.: 14/274,519

(22) Filed: May 9, 2014

(51) Int. Cl. H02H 7/10; H02H 5/04; H02H 3/08; H02H 1/00

(52) U.S. Cl. CPC H02H 7/10; H02H 1/0007; H02H 1/0069; H02H 5/04; H02H 3/08

(57) ABSTRACT

A fault detection circuit for use with a power converter includes an initiate fault check circuit coupled to generate an enable signal in response to a first sense signal coupled to be received from an output socket. A threshold detection circuit is coupled to generate a threshold detection output signal in response to a second sense signal coupled to be received from the power converter and a second reference signal. A logic circuit is coupled to generate a fault signal that is coupled to be received by the power converter in response to the threshold detection output signal and the enable signal.

### BACKGROUND INFORMATION

1. Field of the Disclosure

The present invention relates generally to power converters, and more specifically to power converters utilized to charge powered devices.

2. Background

Electronic devices (such as cell phones, tablets, laptops, etc.) use power to operate. Switched mode power converters are commonly used due to their high efficiency, small size, and low weight to power many of today's electronics. Conventional wall sockets provide a high voltage alternating current. In a switching power converter, a high voltage alternating current (ac) input is converted to provide a well-regulated direct current (dc) output through an energy transfer element to a load. In operation, a switch is utilized to provide the desired output by varying the duty cycle (typically the ratio of the ON time of the switch to the total switching period), varying the switching frequency, or varying the number of pulses per unit time of the switch in a switched mode power converter.

Power may be provided to electronic devices, which may also be referred to as powered devices, through a cable, such as a Universal Serial Bus (USB) cable. The powered device may be powered and/or charged through a charging device, which may include the switched mode power converter. The powered device typically includes a rechargeable battery, and the switched mode power converter typically charges the battery in addition to providing power to operate the powered device. Typically, a cable connects to the charging device and the powered device utilizing a plug interface. Each end of the cable may have a plug that connects to a respective socket of the charging device or the powered device.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1A is a functional block diagram illustrating an example charging device coupled to a power device through a cable in accordance with teachings of the present invention.

FIG. 1B is a pinout diagram illustrating interconnections of a socket and a plug utilized in an example of a charging device in accordance with the teachings of the present invention.

FIG. 2A is a diagram illustrating an example of a switched mode power converter utilized in an example of a charging device in accordance with teachings of the present invention.

FIG. 2B is a diagram illustrating another example of a switched mode power converter utilized in an example of a charging device in accordance with teachings of the present invention.

FIG. 3A is a diagram illustrating an example of a fault detection circuit utilized in an example of a charging device in accordance with teachings of the present invention.

FIG. 3B is a diagram illustrating another example fault detection circuit utilized in an example of a charging device in accordance with teachings of the present invention.

FIG. 4 is a diagram illustrating a further example of a fault detection circuit utilized in an example of a charging device in accordance with teachings of the present invention.

FIG. 5A is a diagram illustrating an example of a switched mode power converter utilized in an example of a charging device in accordance with teachings of the present invention.

FIG. 5B is a diagram illustrating another example switched mode power converter utilized in an example of a charging device in accordance with teachings of the present invention.

FIG. 6 is a flowchart illustrating an example process of detecting an output fault in accordance with teachings of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or subcombinations in one or more embodiments or examples. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

As mentioned above, a charging device (such as a switched mode power converter) may charge and/or power a powered device through a cable, such as a USB cable. During use of the powered device, the powered device may be disconnected from the charging device. The cable may either remain plugged into the charging device or may also be disconnected from the charging device. However, in this no-load condition, a soft short-circuit may develop across the output due to environmental factors such as dust, moisture, a faulty cable, etc. As a result, excessive heat may develop, which could further lead to thermal failures.

In examples of the present disclosure, the socket is monitored to determine if the power converter/charging device should check for a fault, such as a soft short-circuit fault, through a fault detection circuit. In one example, a signal may be received from the socket that indicates that the fault detection circuit should check for a fault. In other words, a signal may be received from the socket that enables the fault detection circuit to check for a fault. Further, the fault detection circuit may be enabled to check for a fault if a signal received from the socket has fallen below a threshold indicating that a no-load condition exists (e.g., the powered device has been unplugged from the charging device).

Once the fault detection circuit is enabled to check for a fault, the fault detection circuit may monitor the output current. If the output current is above a threshold, a fault is detected. In another example, the fault detection circuit may indirectly monitor the output current through the switching frequency of the power converter. If the switching frequency is above a threshold, a fault is detected. In another example, the fault detection circuit may indirectly monitor the output power through the temperature of the output socket. If the temperature is above a threshold, a fault is detected.

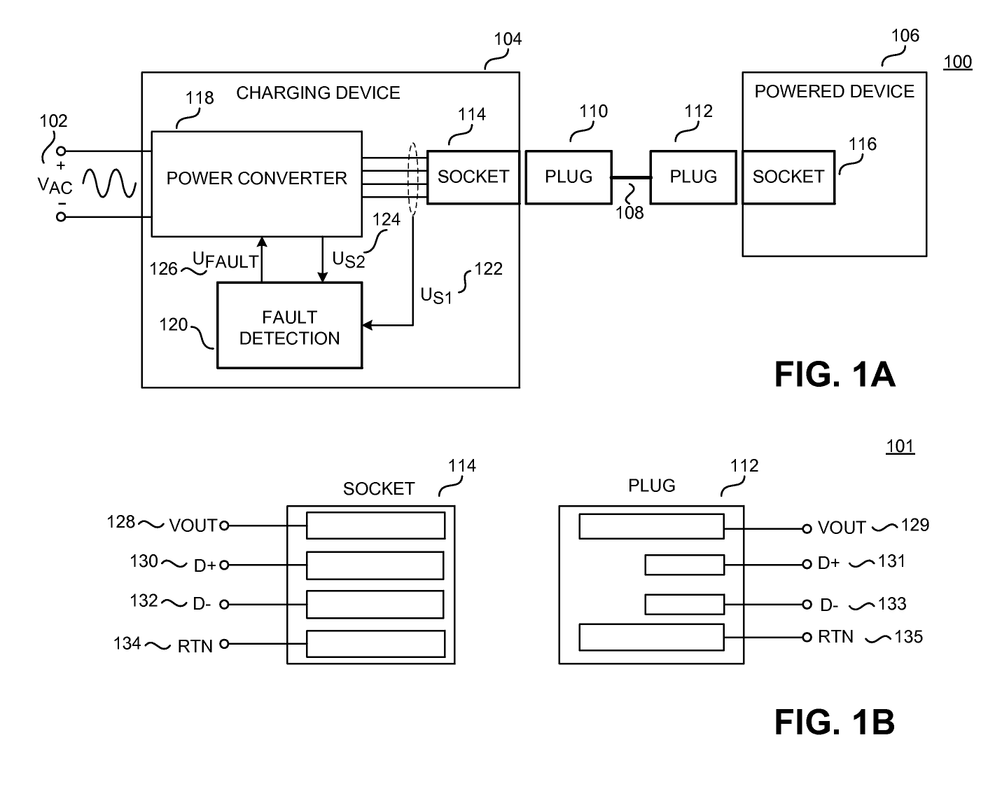

To illustrate, FIG. 1A shows an example of a system 100 including a charging device 104 coupled to a powered device 106 through a cable 108 in accordance with the teachings of the present invention. Plugs 110 and 112 are disposed at each end of the cable 108. Charging device 104 and the powered device 106 include sockets 114 and 116, respectively. As illustrated, charging device 104 also includes power converter 118 and the fault detection circuit 120. Further illustrated in FIG. 1A are an ac input voltage V_{AC} 102, a first sense signal U_{S1} 122, a second sense signal U_{S2} 124, and a fault signal U_{FAULT} 126.

Charging device 104 is coupled to deliver power to the powered device 106 through the cable 108. As illustrated, the charging device 104 and the powered device 106 interface with the cable 108 through sockets 114, 116, and plugs 110, 112. In one example, the socket/plug interface may adhere to socket/plug standards such as for example, but not limited to, USB, mini-USB, etc. It should be appreciated that the socket/plug interface for the charging device 104 need not be the same as the socket/plug interface for the powered device 106. For example, the socket 114 and plug 110 for the charging device 104 may adhere to the USB pinout standard while the socket 116 and plug 112 for the powered device 106 may adhere to the mini-USB or micro-USB standard. As will be further discussed with respect to FIG. 1B, the socket 114 and plug 110 may include terminals for providing power, for providing a return path to ground, and for communicating data.

As shown in the example depicted in FIG. 1A, charging device 104 includes the power converter 118, which is coupled to receive ac input voltage V_{AC} 102, and provides a regulated output to the socket 114. The regulated output is then delivered to the powered device 106 when the powered device 106 is connected via cable 108 to charging device 104. The power converter 118 may also provide the second sense signal U_{S2} 124. A fault detection circuit 120 is further included in the charging device 104. In the depicted example, the fault detection circuit 120 is coupled to receive the first sense signal U_{S1} 122, the second sense signal U_{S2} 124, and output the fault signal U_{FAULT} 126. As illustrated, the first sense signal U_{S1} 122 may be representative of one or more terminals of the socket 114. In addition, second sense signal U_{S2} 124 may be representative of an output (such as an output current) of the power converter 118. In one example, the switching frequency of the power converter 118 is proportional to the output of the power converter 118. As such, the second sense signal U_{S2} 124 may be representative of the switching frequency of the power converter 118. In another example, the output of the power converter 118 may be sensed using temperature. The fault detection circuit 120 outputs the fault signal U_{FAULT} 126 in response to the first sense signal U_{S1} 122 and the second sense signal U_{S2} 124. The fault signal U_{FAULT} 126 is representative of whether the fault detection circuit 120 has detected a fault. Although the fault detection circuit 120 is illustrated as separate from the power converter 118, it should be appreciated that the fault detection circuit 120 could be included in the power converter 118.

As will be further discussed, the fault detection circuit 120 is enabled to check for a fault in response to the first sense signal U_{S1} 122. In one example, the first sense signal U_{S1} 122 may be responsive to a command (such as a command from the powered device 106) to enable the fault detection circuit 120. In another example, the first sense signal U_{S1} 122 may fall below a first threshold to automatically enable the fault detection circuit 120. Further, in one example the fault detection circuit 120 detects a fault when the second sense signal U_{S2} 124 is greater than a second threshold.

FIG. 1B illustrates one example of an example pinout diagram 101 for the interconnections of socket 114 and plug 110. In one example, the pinout diagram 101 is for a USB socket and plug. It is appreciated of course the a USB socket is discussed for explanation purposes, and that other types of sockets and plugs may also be utilized in accordance with the teachings of the present invention. As shown in the depicted example, socket 114 includes output terminal VOUT 128, data terminal D+ 130, data terminal D− 132, and return terminal RTN 134. The plug 110 includes VOUT 129, data terminal D+ 131, data terminal D− 133, and return terminal RTN 135, which correspond to the similarly named terminals included in socket 114. In operation, the plug 110 connects to the socket 114 at the correspondingly named terminals. In the example, the terminals of plug 110 are also coupled to corresponding terminals in plug 112 through cable 108. Similarly, terminals in socket 116 are coupled to corresponding terminals in plug 112 when plug 112 is plugged into socket 116 in operation. Thus, power may be transferred through cable 108 and through the socket/plug interface. For instance, power may be transferred through the output terminals VOUT 128 and 129 with a return path via return terminals RTN 134 and 135. In addition, the powered device 106 and charging device 104 may communicate through the data terminals D+ 130, D+ 131, D− 132, and D− 133, of sockets 114 and 116, and plugs 112 and 110.

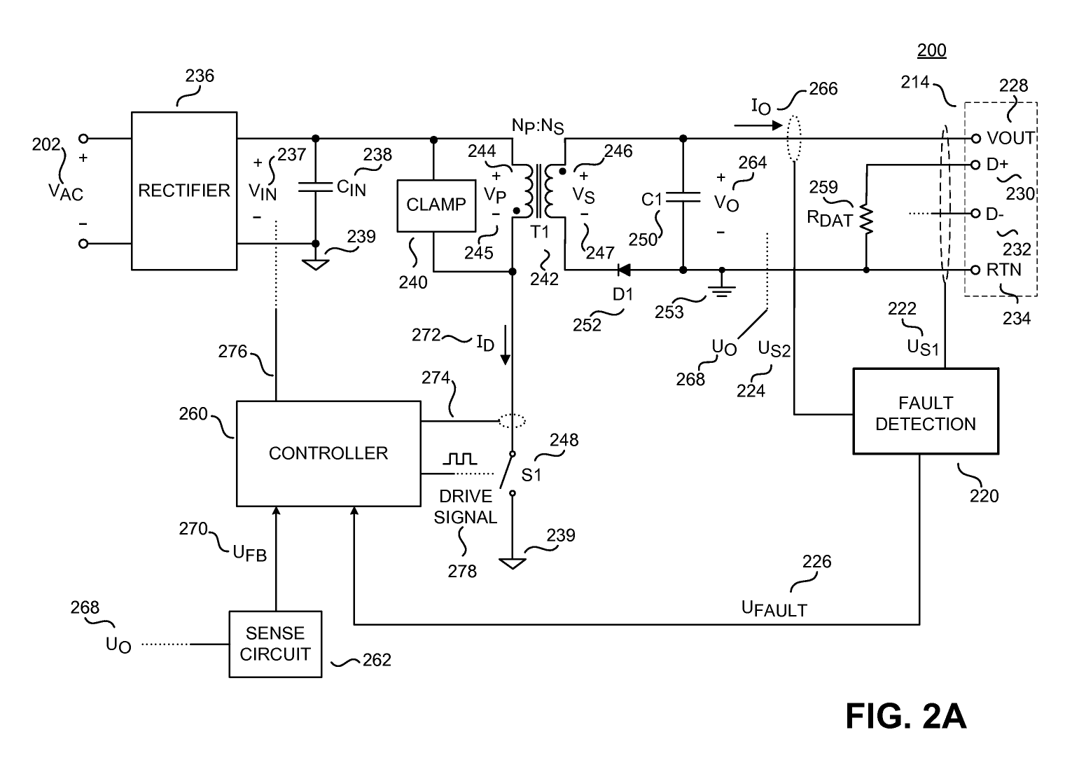

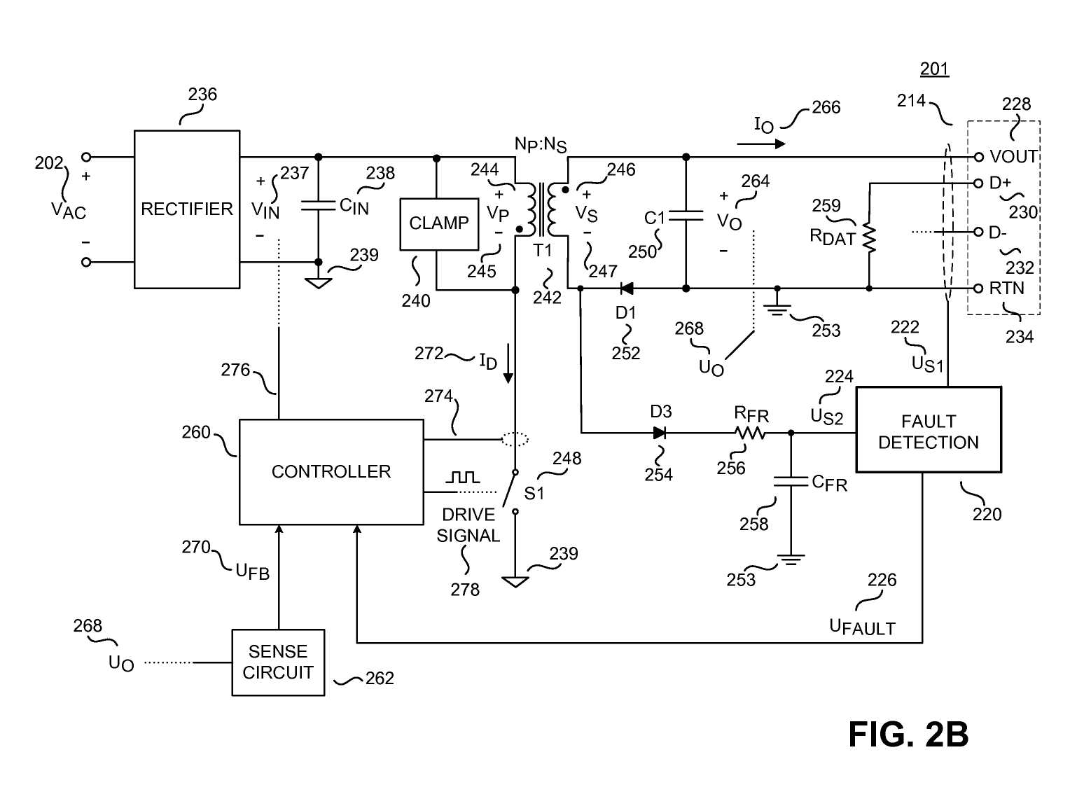

FIG. 2A is a diagram illustrating an example of a switched mode power converter utilized in an example of a charging device 200 in accordance with teachings of the present invention. As shown in the depicted example, charging device 200 includes ac input voltage V_{AC} 202 received by the power converter, socket 214, fault detection circuit 220, first sense signal U_{S1} 222, second sense signal U_{S2} 224, and fault signal U_{FAULT} 226. It is appreciated that charging device 200 may be one example of charging device 104 illustrated in FIG. 1, and that similarly named elements referenced below are coupled and function similar to as described above. As shown in the depicted example, the switched mode power converter further includes a rectifier 235, an input capacitor 238, an input return 239, a clamp circuit 240, an energy transfer element T1 242, a primary winding 244 of the energy transfer element T1 242, a secondary winding 246 of the energy transfer element T1 242, a power switch S1 248, an output capacitor C1 250, an output rectifier D1 252, output return 253, a resistance R_{DAT} 259 (optional), a controller 260, and a sense circuit 252. The socket 214 includes the output terminal VOUT 228, data terminal D+ 230, data terminal D− 232, and return terminal RTN 234. Further illustrated in FIG. 2A are the input voltage V_{IN} 237, primary voltage V_{P} 245, secondary voltage V_{S} 247, output voltage V_{O} 264, output current I_{O} 266, output quantity U_{O} 268, feedback signal U_{FB} 270, switch current I_{D} 272, switch current sense signal 274, input sense signal 276, and drive signal 278. It is noted that the example switched mode power converter shown in FIG. 2A is coupled in a flyback configuration. It is appreciated that other known topologies and configurations may benefit from the teachings of the present invention. In addition, the power converter illustrated is an isolated power converter. It should be appreciated that non-isolated power converters may also be used in accordance with the teachings of the present invention.

In the depicted example, the power converter provides output power from an unregulated input voltage, such as ac input voltage V_{AC} 102. The rectifier 236 is coupled to receive the ac input voltage V_{AC} 102 and outputs the input voltage V_{IN} 237. In another example, the input voltage is a rectified ac input voltage, such as input voltage V_{IN} 237. In one example, the rectifier 236 may be a bridge rectifier. The rectifier 236 further couples to the energy transfer element T1 242. In some embodiments of the present invention, the energy transfer element T1 242 may be a coupled inductor, a transformer, or an inductor. In the example shown, the energy transfer element T1 242 includes two windings, a primary winding 244 (with NP turns) and a secondary winding 246 (with NS turns). However, it should be appreciated that the energy transfer element T1 242 may have more than two windings. The voltage across the primary 244 and secondary 246 windings are labeled as primary voltage V_{P} 245 and secondary voltage V_{S} 246. The primary voltage V_{P} 245 and secondary voltage V_{S} 246 are related by the turns ratio (NP:NS) of the energy transfer element T1 242. In the example of FIG. 2A, primary winding 244 may be considered an input winding, and secondary winding 246 may be considered an output winding. The primary winding 244 is coupled to the power switch S1 248 and the power switch 248 is further coupled to input return 239.

In addition, the clamp circuit 240 is illustrated as being coupled across the primary winding 244. The input capacitor C_{IN} 238 may be coupled across the primary winding 244 and the switch S1 248. In other words, the input capacitor C_{IN} 238 may be coupled to the rectifier 236 and input return 239. In the depicted example, secondary winding 246 is coupled to the rectifier D1 252. In the example of FIG. 2A, the rectifier D1 252 is exemplified as a diode. However, in another example, the rectifier D1 252 may be a transistor used as a synchronous rectifier. Both the output capacitor C1 250 and the resistance R_{DAT} 259 are shown as being coupled to the rectifier D1 252 and the output return 253 in the depicted example. In the example shown, the output capacitor C1 is also coupled to the output terminal VOUT 228 of socket 214 while the resistance R_{DAT} 259 may be coupled to the data terminal D+ 230. In addition, return terminal RTN 234 may be coupled to output return 253. An output is provided to the socket 214 and may be provided as either a regulated output voltage Vo 264, regulated output current Io 266, or a combination of the two. In the example of FIG. 2A, input voltage V_{IN} 237 is positive with respect to an input return 239, and output voltage V_{O} 264 is positive with respect to an output return 253.

The power converter further includes circuitry to regulate the output, which is exemplified as output quantity U_{O} 268 from the output of the power converter. In general, the output quantity U_{O} 268 is either an output voltage V_{O} 264, an output current I_{O} 266, or a combination of the two. A sense circuit 262 is coupled to sense the output quantity U_{O} 268 and to provide feedback signal U_{FB} 270, which is representative of the output quantity U_{O} 268. Feedback signal U_{FB} 270 may be a voltage signal or a current signal. In one example, the sense circuit 262 may sense the output quantity U_{O} 268 from an additional winding included in the energy transfer element T1 242. In a further example, the sense circuit 262 may utilize a voltage divider to sense the output quantity U_{O} 268 from the output of the power converter.

As shown in the depicted example, controller 260 is coupled to receive the feedback signal U_{FB} 270 from the sense circuit 262. The controller 260 further includes terminals for receiving the input sense signal 276, switch current sense signal 274 and for providing the drive signal 278 to the power switch S1 248. In the example of FIG. 2A, the input sense signal 276 may be representative of the input voltage V_{IN} 237. The input sense signal 276 may be a voltage signal or a current signal. The switch current sense signal 274 may be representative of the switch current I_{D} 272 in the power switch S1 248. Switch current sense signal 274 may be a voltage signal or a current signal. In addition, the controller 260 provides drive signal 278 to the power switch S1 248 to control various switching parameters to control the transfer of energy from the input of power converter to the output of power converter. Examples of such parameters may include switching frequency (or period), duty cycle, ON and OFF times of the power switch S1 248, or varying the number of pulses per unit time of the power switch S1 248.

As shown in the depicted example, fault detection circuit 220 is coupled to receive the second sense signal U_{S2} 224 and the first sense signal U_{S1} 222 and outputs the fault signal U_{FAULT} 226. As illustrated, the first sense signal U_{S1} 222 may be representative of one or more of the terminals of socket 214. The first sense signal U_{S1} 222 may a voltage signal or a current signal. In one example, the first sense signal U_{S1} 222 may be the signal received from the data terminal D+ 230. The second sense signal U_{S2} 224 may be representative of the output load of the power converter. The second sense signal U_{S2} 224 may be a voltage signal or a current signal. In one example the second sense signal U_{S2} 224 may be representative of the current I_{O} 266. In one example, as shown in FIG. 2A, the output current I_{O} 266 is sensed from the high side of the power converter output, but it should be appreciated that the output current I_{O} 266 may be sensed from the low side. In another example, the second sense signal U_{S2} 224 may be representative of the output load by sensing the switching frequency of the power converter. In a further example, the second sense signal U_{S2} 224 may be representative of the output power by sensing the temperature of the output load. FIG. 2A illustrates an example in which the fault signal U_{FAULT} 226 is received by controller 260. In one example, the power converter may prevent the switching of switch S1 248 in response to the fault signal U_{FAULT} 226. In one example, the fault signal U_{FAULT} 226 may cross an isolation barrier between the primary and secondary side of the power converter.

In operation, the power converter provides output power from an unregulated input such as the ac input voltage V_{AC} 202. The rectifier 236 rectifies the ac input voltage V_{AC} 202 and produces the input voltage V_{IN} 237. The input capacitor C_{IN} 238 filters the high frequency current from the switch S1 248. For some applications, the input capacitor C_{IN} 238 may be large enough such that a substantially constant dc voltage is applied to the energy transfer element T1 242. However, for power supplies with power factor correction (PFC), a small input capacitor C_{IN} 238 may be utilized to allow the voltage applied to the energy transfer element T1 242 to substantially follow the positive magnitude of the ac input voltage V_{AC} 202.

As shown in the example depicted in FIG. 2A, the power converter utilizes the energy transfer element T1 242 to transfer energy between the primary 114 and the secondary 116 windings. The clamp circuit 240 is coupled to the primary winding 244 to limit the maximum voltage on the switch S1 248. The voltage across the clamp 240 may be limited to a clamp voltage V_{CLAMP}. Switch S1 248 is opened and closed in response to the drive signal 278. It is generally understood that a switch that is closed may conduct current and is considered on, while a switch that is open cannot conduct current and is considered off. In one example, the switch S1 248 may be a transistor such as a metal-oxide-semiconductor field-effect transistor (MOSFET). In another example, controller 260 may be implemented as a monolithic integrated circuit or may be implemented with discrete electrical components or a combination of discrete and integrated components. Controller 260 and switch S1 248 could form part of an integrated circuit that is manufactured as either a hybrid or monolithic integrated circuit. In operation, the switching of the switch S1 248 produces a pulsating current at the rectifier D1 252. The current is filtered by the output capacitor C1 250 to produce a substantially constant output voltage V_{O} 264, output current I_{O} 266, or a combination of the two at the socket 214.

In example illustrated in FIG. 2A, sense circuit 262 senses the output quantity U_{O} 268 of the power converter to provide the feedback signal U_{FB} 270 to the controller 260. The feedback signal U_{FB} 270 provides information regarding the output quantity U_{O} 268 to the controller 260. In addition, the controller 260 may receive the switch current sense signal 274, which in one example is representative of the switch current I_{D} 272 in the switch S1 248. The switch current I_{D} 272 may be sensed in a variety of ways, such as for example the voltage across a discrete resistor or the voltage across a transistor when the transistor is conducting. In addition, the controller 260 may receive the voltage sense signal 276, which in one example is representative of the value of the input voltage V_{IN} 237. The input voltage V_{IN} 237 may be sensed a variety of ways, such as for example through a resistor divider.

In operation, the fault detection circuit 220 is enabled to check for a fault in response to the first sense signal U_{S1} 222. In one example, the first sense signal U_{S1} 222 may send a command (such as a command from the powered device coupled to the power converter through socket 214) to enable the fault detection circuit 220 to check for a fault. In another example, the first sense signal U_{S1} 222 may fall below a first threshold to automatically enable the fault detection circuit 220 to check for a fault. For example, the first sense signal U_{S1} 222 may be the voltage of data terminal D+ 230. Once a powered device is disconnected from the power converter, the voltage on data terminal D+ 230 may be pulled low through the resistor R_{DAT} 259. The voltage on the data terminal D+ 230 may fall below the first threshold and enable the fault detection circuit 220. In one example, it should be appreciated that the single first sense signal U_{S1} 222 may be representative of the signals on one or more of the terminals of the socket 214.

In one example, once the fault detection circuit 220 is enabled, the fault detection circuit 220 detects a fault in response to the second sense signal U_{S2} 224 being greater than a set value. For example, a fault may be detected when the second sense signal U_{S2} 224 is greater than a second threshold, indicating that the second sense signal U_{S2} 224 being greater than the value. When the second sense signal U_{S2} 224 is representative of the output current I_{O} 266, a fault is detected when the second sense signal U_{S2} 224 is greater than the second threshold, indicating the sensed output current I_{O} 266 is greater than the set value. In another example, when the second sense signal U_{S2} 224 is representative of the switching frequency, a fault is detected when the second sense signal U_{S2} 224 is greater than the second threshold, indicating the sensed switching frequency is greater than the set value. As will be discussed further, when the second sense signal U_{S2} 224 is representative of the temperature, a fault may be detected when the second sense signal U_{S2} 224 has fallen below the second threshold, indicating that the temperature is greater than the set value. In one example, fault signal U_{FAULT} 226 indicates whether a fault condition has been detected. Fault signal U_{FAULT} 226 may be a rectangular pulse waveform of varying lengths of logic high or logic low sections. Logic high may mean that a fault has been detected while logic low may mean no fault has been detected (or vice versa). In another example, the fault signal U_{FAULT} 226 may pulse to a logic high value and quickly fall to a low value to indicate that a fault condition has been detected.

In one example, the controller 260 is disabled and prevented from switching the switch S1 248 when the fault signal U_{FAULT} 226 indicates that a fault is detected. In another example, the fault signal U_{FAULT} 226 disables the power converter and prevents the switch S1 248 from switching when a fault is detected. By sensing a fault and disabling the switch S1 248, damage due to a fault such as a soft-short may be prevented in accordance with the teachings of the present invention.

FIG. 2B is a diagram illustrating another example of a switched mode power converter utilized in an example of a charging device 201 in accordance with teachings of the present invention. As shown in the depicted example, charging device 201 includes the ac input voltage V_{AC} 202 received by the power converter, socket 214, and fault detection circuit 220, first sense signal U_{S1} 222, second sense signal U_{S2} 224, and fault signal U_{FAULT} 226. It is appreciated that charging device 201 may be another example of charging device 104 illustrated in FIG. 1, and that similarly named elements referenced below are coupled and function similar to as described above. As shown in the depicted example, the switched mode power converter further includes rectifier 235, input capacitor 238, input return 239, clamp circuit 240, energy transfer element T1 242, primary winding 244 of the energy transfer element T1 242, secondary winding 246 of the energy transfer element T1 242, power switch S1 248, output capacitor C1 250, output rectifier D1 252, output return 253, a diode D3 254, a resistance R_{FR} 256, and a capacitance C_{FR} 258, resistance R_{DAT} 259 (optional), controller 260, and sense circuit 252. The socket 214 includes the output terminal VOUT 228, data terminal D+ 230, data terminal D− 232, and return terminal RTN 234. Further illustrated in FIG. 2B are the input voltage V_{IN} 237, primary voltage V_{P} 245, secondary voltage V_{S} 247, output voltage V_{O} 264, output current I_{O} 266, output quantity U_{O} 268, feedback signal U_{FB} 270, switch current I_{D} 272, switch current sense signal 274, input sense signal 276, and drive signal 278. It is noted that the example switched mode power converter shown in FIG. 2B is coupled in a flyback configuration. It is appreciated that other known topologies and configurations may benefit from the teachings of the present invention. In addition, the power converter illustrated is an isolated power converter. It should be appreciated that non-isolated power converters may also be used in accordance with the teachings of the present invention.

The charging device 201 illustrated in FIG. 2B shares similarities with the charging device 200 illustrated in FIG. 2A, and that similarly named elements referenced below are coupled and function similar to as described above. One difference between charging device 201 of FIG. 2B and charging device 200 of FIG. 2A is that charging device 201 of FIG. 2B includes the addition of diode D3 254, resistance R_{FR} 256, and capacitance C_{FR} 258 as shown. In particular, one end of diode D3 254 (the anode end) is coupled to the secondary winding 246 while the other end is coupled to the resistance R_{FR} 256. Resistance R_{FR} 256 and capacitance C_{FR} 258 are coupled to the fault detection circuit 220 and provide the second sense signal U_{S2} 224. The capacitance C_{FR} 258 is further coupled to output return 253. As mentioned above, the second sense signal U_{S2} 224 may be representative of the output load of the power converter through the switching frequency. In general, the frequency of the secondary voltage V_{S} 246 is substantially equal to the switching frequency. In operation, the resistance R_{FR} 256 and capacitance C_{FR} 258 filter the secondary voltage V_{S} 246 to provide the second sense signal U_{S2} 224 which is representative of the switching frequency of the power converter. The switching frequency provided by the second sense signal U_{S2} 224 is then compared to the second threshold by the fault detection circuit 220 to detect a fault condition in accordance with the teachings of the present invention. In another example, second sense signal U_{S2} 224 could be received by the fault detection circuit 220 from a direct connection to the output winding 246 of the energy transfer element T1 242 (without components D3 254, C_{FR} 258 and R_{FR} 256). In this example, the fault detection circuit 220 could derive information regarding the output loading of the power converter through the frequency of the second sense signal U_{S2} 224 which could be decoded by the fault detection circuit 220.

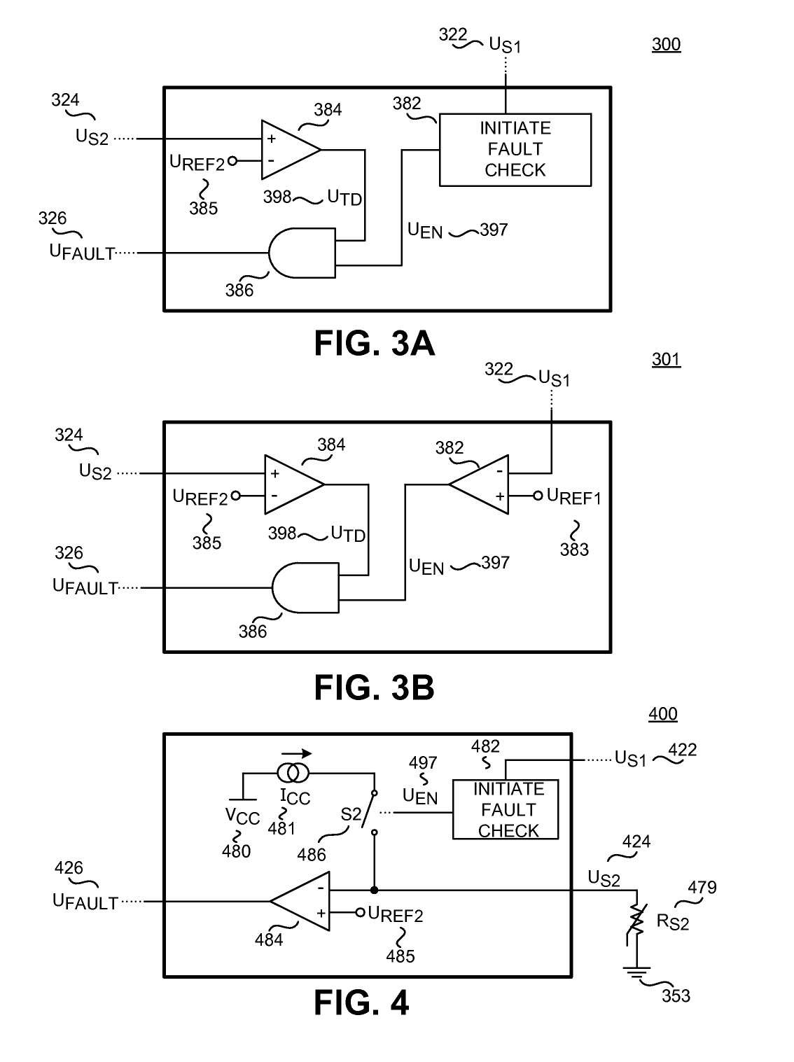

FIG. 3A is a diagram illustrating an example of a fault detection circuit 400 utilized in an example of a charging device in accordance with teachings of the present invention. As shown in the depicted example, fault detection circuit 300 includes initiate fault check block 382, threshold detection circuit 384 (exemplified as comparator 384), and logic circuit 386 (exemplified as AND gate 386). Further illustrated in FIG. 3 are first sense signal U_{S1} 322, second sense signal U_{S2} 324, fault signal U_{FAULT} 326, a second reference U_{REF2} 385, an enable signal U_{EN} 397, and a threshold detection output signal U_{TD} 398.

As illustrated, the initiate fault check circuit 382 is coupled to receive the first sense signal U_{S1} 322 and output the enable signal U_{EN} 397. The enable signal U_{EN} 397 may be voltage signal or a current signal. Further, the enable signal U_{EN} 397 may be a rectangular pulse waveform with varying lengths of logic high and logic low sections. In one example, the enable signal U_{EN} 397 may be logic high to enable the fault detection circuit 300 to detect a fault and logic low to disable the fault detection circuit 300 from detecting to a fault. In another example, the enable signal U_{EN} 397 may pulse to a logic high value and fall to a logic low value to enable the fault detection circuit 300 to detect a fault. In one example, the initiate fault check circuit 382 may include various logic gates, a state machine, or a micro controller to translate the first sense signal U_{S1} 322 to the enable signal U_{EN} 397. As will be discussed later, the initiate fault check circuit 382 may also include a comparator.

In the illustrated example, the threshold detection circuit 384 is coupled to receive the second sense signal U_{S2} 324 and output the threshold detection output signal U_{TD} 398. The threshold detection circuit 384 further receives the second reference U_{REF2} 385. The threshold detection output signal U_{TD} 398 may be voltage signal or a current signal. Further, the threshold detection output signal U_{TD} 398 may be a rectangular pulse waveform with varying lengths of logic high and logic low sections. In the example shown, the threshold detection circuit 384 is exemplified as a comparator 384. Second sense signal U_{S2} 324 may be received at the non-inverting input of the comparator 484 while the second reference U_{REF2} 385 may be received at the inverting input of the comparator 384. Threshold detection output signal U_{TD} 398 may be logic high when the second sense signal U_{S2} 324 is greater than the second reference U_{REF2} 385 and logic low otherwise.

The logic circuit 386 is illustrated as receiving the enable signal U_{EN} 397 and the threshold detection output signal U_{TD} 398. Further, the logic circuit 386 outputs the fault signal U_{FAULT} 326. In the example shown, logic circuit 386 is exemplified as AND gate 386. The fault signal U_{FAULT} 326 output from the AND gate 386 is logic high when both the enable signal U_{EN} 397 and the threshold detection output signal U_{TD} 398 are logic high. The output of AND gate 386 is logic low otherwise.

In operation, the initiate fault check circuit 382 generates the enable signal U_{EN} 397 in response to the first sense signal U_{S1} 322. In one example, first sense signal U_{S1} 322 may be a command signal, which enables the fault check circuit 382 to determine whether there is a fault. In the example, initiate fault check circuit 382 generates the enable signal U_{EN} 397 such that the logic circuit 386 may receive the enable signal U_{EN} 397. The enable signal U_{EN} 397 enables the logic circuit 386 to respond to detected faults. Once enabled, the fault detection circuit 300 indicates that a fault condition is detected when the second sense signal U_{S2} 324 is greater than a second reference U_{REF2} 385. In the depicted example, the fault signal U_{FAULT} 326 output from the AND gate 386 is logic high when both the enable signal U_{EN} 397 and the threshold detection output signal U_{TD} 398 are logic high. The threshold detection output signal U_{TD} 398 is logic high when the second sense signal U_{S2} 324 is greater than the second reference U_{REF2} 385. As mentioned above, the second sense signal U_{S2} 324 may be representative (directly or indirectly) of an output of the power converter. A fault may exist when threshold detection output signal U_{TD} 398 is logic high.

For instance, in an example in which the second sense signal U_{S2} 324 is representative of the switching frequency of the power switch, a logic high value for the threshold detection output signal U_{TD} 398 may indicate the switching frequency is too high and the fault signal U_{FAULT} 326 is asserted. For another example in which the second sense signal U_{S2} 324 is representative of the output current, a logic high value for the threshold detection output signal U_{TD} 398 may indicate that the output current is too high and the fault signal U_{FAULT} 326 is asserted. For a further example in which the second sense signal U_{S2} 324 is representative of the temperature, a logic high value for the threshold detection output signal U_{TD} 398 may indicate that the temperature is too high and the fault signal U_{FAULT} 326 is asserted. In one example, if a fault condition is detected, the fault signal U_{FAULT} 326 disables the power converter and prevents the switch S1 248 from switching.

FIG. 3B is a diagram illustrating another example fault detection circuit 301 utilized in an example of a charging device in accordance with teachings of the present invention. As shown in the depicted example, fault detection circuit 301 includes initiate fault check block 382 (exemplified as the comparator 382), threshold detection circuit 384 (exemplified as comparator 384), and logic circuit 386 (exemplified as AND gate 386). Further illustrated in FIG. 3B are first sense signal U_{S1} 322, second sense signal U_{S2} 324, fault signal U_{FAULT} 326, a first reference signal U_{REF1} 383, second reference U_{REF2} 385, enable signal U_{EN} 397 and threshold detection output signal UTA 398.

It is noted that FIG. 3B shares similarities with FIG. 3A. However, a difference between fault detection circuit of FIG. 3B and fault detection circuit 300 of FIG. 3A is that the initiate fault check block 382 is exemplified in FIG. 3B as a comparator 382. In the example shown, the comparator 382 is coupled to receive the first sense signal U_{S1} 322 at its inverting input while the first reference signal U_{REF1} 383 is received at the non-inverting input. Comparator 382 outputs the enable signal U_{EN} 397 in response to the comparison of the first sense signal U_{S1} 322 and the first reference signal U_{REF1} 383. The enable signal U_{EN} 397 is logic high when the first reference signal U_{REF1} 383 is greater than the first sense signal U_{S1} 322 and logic low otherwise. In one example, the first sense signal U_{S1} 322 may be representative of the signals on one or more of the terminals of the socket discussed above. For example, one or more terminals of the socket may fall to below the first reference signal U_{REF1} 383 when there is a no-load condition (such as a disconnection of a powered device and/or cable from the socket). For example, the first sense signal U_{S1} 322 may be the voltage of data terminal D+. The voltage on the data terminal D+ may be pulled low once a powered device is disconnected from the power converter. The voltage on the data terminal D+ 330 may fall below the first reference signal U_{REF1} 383. The enable signal U_{EN} 397 transitions to a logic high value and enables the logic circuit 386. Therefore, in one example, initiate fault check block 382 of FIG. 3B enables the fault detection circuit 301 when a no-load or a light load condition is sensed by first sense signal U_{S1} 322 falling below first reference signal U_{REF1} 383.

FIG. 4 is a diagram illustrating an example of a fault detection circuit 400 utilized in an example of a charging device in accordance with teachings of the present invention. As shown in the depicted example, fault detection circuit 400 includes initiate fault check block 482, threshold detection circuit 484 (exemplified as comparator 484), a voltage source 480 which provides voltage V_{CC} 480, a current source 481 which provides current I_{CC}, and a switch 486. Further illustrated in FIG. 4 are first sense signal U_{S1} 422, second sense signal U_{S2} 424, fault signal U_{FAULT} 426, a temperature sense R_{S2} 479, and second reference U_{REF2} 485, and an enable signal U_{EN} 497. The fault detection circuit 400 illustrated receives a second sense signal U_{S2} 424 representative of the temperature of the output of the power converter. In another example, the second sense signal U_{S2} 424 may be representative of the temperature of the output socket.

It is noted that FIG. 4 shares similarities with FIG. 3A and FIG. 3B. However, the fault detection circuit 400 further includes voltage source 480 which provides voltage V_{CC} 480, a current source 481 which provides current I_{CC}, switch S2 486 and temperature sense R_{S2} 479. Temperature sense R_{S2} 479 is exemplified as a thermistor 479. In one example, the temperature sense R_{S2} 479 may be a negative temperature coefficient (NTC) thermistor. Although, a positive temperature coefficient (PTC) thermistor may also be utilized. Although not shown, the temperature sense R_{S2} 479 may be placed proximate to the output socket to indirectly sense the power dissipated in the socket during a fault condition. One end of temperature sense R_{S2} 479 is coupled to output return 353 while the other end is coupled to the fault detection circuit 400. In the example illustrated, the second sense signal U_{S2} 424 may be provided from the temperature sense R_{S2} 479 as the voltage across the temperature sense R_{S2} 479. The temperature sense R_{S2} 479 is coupled to the inverting input of the comparator 484. Or in other words, the second sense signal U_{S2} 424 is received at the inverting input of the comparator 484. Further coupled to the inverting input of the comparator 484 is switch S2 486. The other end of switch S2 486 is coupled to the current source 481 and the voltage source 480. The switch S2 486 is also coupled to receive the enable signal U_{EN} 497. As will be discussed, the switch S2 486 opens and closes in response to the enable signal U_{EN} 497. The comparator 484 is further coupled to receive the second reference U_{REF2} 485 at its non-inverting input and output the fault signal U_{FAULT} 426.

In operation, the enable signal U_{EN} 497 turns on the switch S2 486 when it is determined that the fault detection circuit 400 should check for a fault. The current I_{CC} provided by current source 481 flows to temperature sense R_{S2} 479. In one example, the temperature sense R_{S2} 479 is an NTC thermistor and the value of the resistance decreases as the sensed temperature increases. As the temperature increases, the value of the resistance decreases and the second sense signal U_{S2} 424 decreases. When the second sense signal U_{S2} 424 decreases below the second reference U_{REF2} 485, the fault signal U_{FAULT} 426 outputs a logic high value indicating that a fault has been detected.

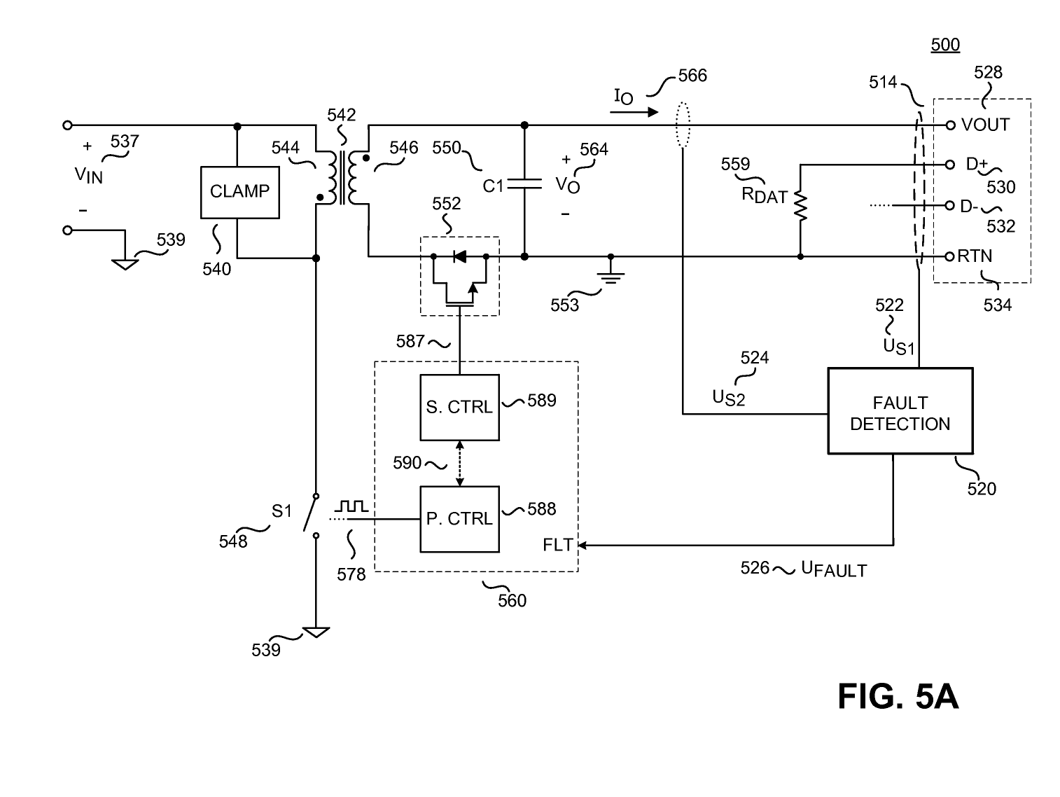

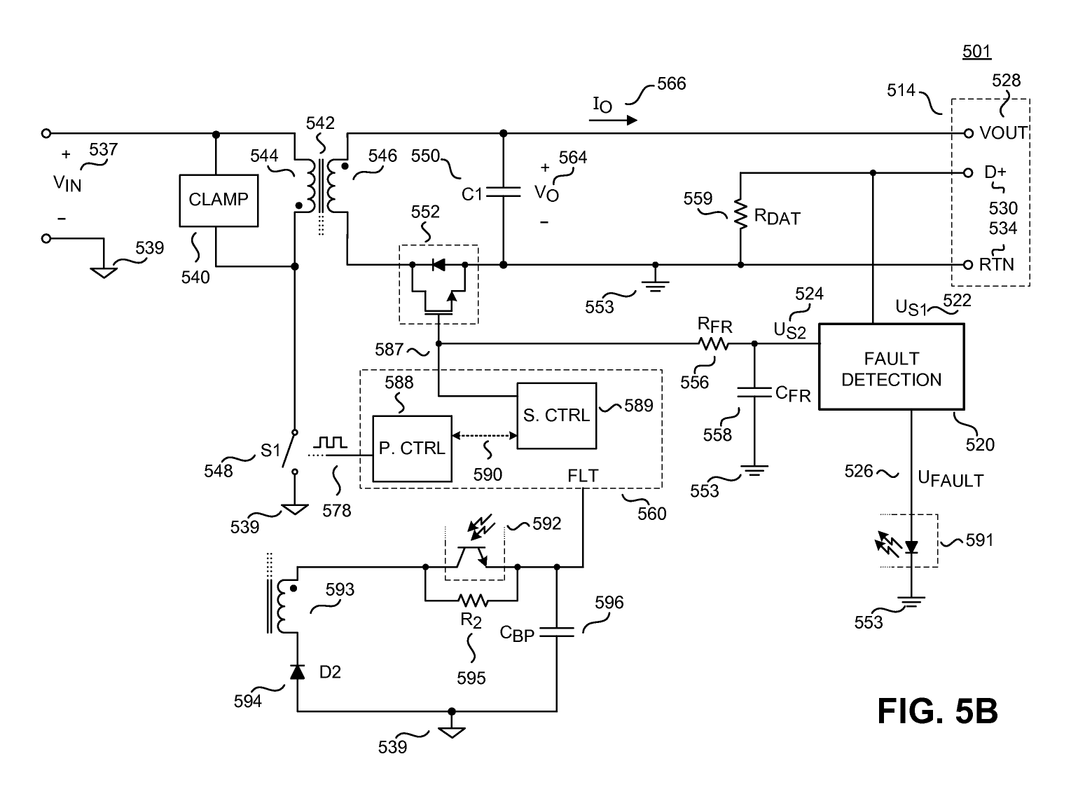

FIG. 5A is a diagram illustrating an example of a switched mode power converter utilized in an example of a charging device 500 in accordance with teachings of the present invention. In particular, as shown in the depicted example, charging device 500 includes a power converter, socket 514, fault detection circuit 520, first sense signal U_{S1} 522, second sense signal U_{S2} 524, and fault signal U_{FAULT} 526. The charging device 500 may be one example of charging device 104 illustrated in FIG. 1. The power converter further includes a rectifier input return 539, clamp circuit 540, energy transfer element T1 542, primary winding 544 of the energy transfer element T1 542, secondary winding 546 of the energy transfer element T1 542, power switch S1 548, output capacitor C1 550, an output rectifier 552, output return 553, resistance R_{DAT} 559 (optional), and a controller 560. The socket 514 includes the output terminal VOUT 528, data terminal D+ 530, data terminal D− 532, and return terminal RTN 534. Further illustrated in FIG. 5A are the input voltage V_{IN} 537, output voltage V_{O} 564, output current I_{O} 566, drive signal 578, and a secondary drive signal 587. The controller 560 is further illustrated as including the primary controller 588 and the secondary controller 589 with a communication link 590 between the controllers 588 and 589.

The example power converter shown in FIG. 5A is similar to the power converters illustrated in FIGS. 2A and 2B, however, the output rectifier 552 is exemplified as a synchronous rectifier and the controller 560 may include the primary controller 588 and the secondary controller 589. It should also be appreciated that certain elements that were illustrated in FIGS. 2A and 2B for explanation purposes have been omitted from FIG. 5A so as not to obscure the teachings of the present invention. Similarly named and numbered elements are coupled and function as described above.

As shown in the example depicted in FIG. 5A, the synchronous rectifier 552 is coupled to the secondary winding 546 and the output capacitor 550. In the example shown, the synchronous rectifier 552 includes a switch (exemplified as a transistor) and a diode. In one example, the diode may be an externally connected Schottky diode. The synchronous rectifier 552 is coupled to receive the secondary drive signal 587 from the secondary controller 589. Primary controller 588 and the secondary controller 589 may be implemented as monolithic integrated circuits or may be implemented with discrete electrical components or a combination of discrete and integrated components. Primary controller 588, secondary controller 589, and switch S1 548 could form part of an integrated circuit that is manufactured as either a hybrid or monolithic integrated circuit. However it should be appreciated that both the primary controller 588 and the secondary controller 589 need not be included in a single controller package.

The primary controller 588 is coupled to output the drive signal 578 to control switching of the power switch S1 548. The secondary controller 589 is coupled to output the secondary drive signal 587 to control switching of the synchronous rectifier 552. Primary controller 588 and secondary controller 589 may communicate via a communication link 590. Although not shown, the secondary controller 589 may receive a feedback signal representative of the output of the power converter and determines whether the power switch S1 548 should be turned on during a given switching cycle period, or the duration of time that switch S1 548 should be turned on during a switching cycle period. The secondary controller 589 may send a command to the primary controller 588 via the communication link 590 to turn on the power switch S1 548. In the example, the primary switch S1 548 and the synchronous rectifier 552 are generally not turned on at the same time. In one example, synchronous rectifier 552 is turned on for a period of time that current flows in secondary winding 546 following a turn off event of primary switch S1 548. The exact timing of the synchronous rectifier 552 turn on and turn off are determined through signals not shown in FIG. 5A so as not to obscure the teachings of the present invention.

Similar to the example discussed above in FIG. 2A, fault detection circuit 520 is illustrated as being coupled to receive the second sense signal U_{S2} 524 and the first sense signal U_{S1} 522, and output the fault signal U_{FAULT} 526. As illustrated, the first sense signal U_{S1} 522 may be representative of one or more of the terminals of socket 514. The second sense signal U_{S2} 524 may be representative of the output load of the power converter. In one example, the second sense signal U_{S2} 524 may be representative of the current I_{O} 566. As shown in the example depicted in FIG. 5A, the output current I_{O} 566 is sensed from the high side of the power converter output, but it should be appreciated that the output current I_{O} 566 may be sensed from the low side. In another example, the second sense signal U_{S2} 524 may be representative of the output load by sensing the switching frequency of the power converter. FIG. 5A illustrates that the fault signal U_{FAULT} 526 is coupled to be received by controller 560 at a fault terminal FLT. In one example, the power converter prevents the switch S1 548 from switching in response to the fault signal U_{FAULT} 526. In various examples, the fault signal U_{FAULT} 526 may be received by the primary controller 588, the secondary controller 589, or both the primary controller 588 and the secondary controller 589 through the fault terminal FLT.

In operation, the fault detection circuit 520 is enabled to check for a fault in response to the first sense signal U_{S1} 522. In one example, the first sense signal U_{S1} 522 may send a command (such as a command from the powered device) to enable the fault detection circuit 520. In another example, the first sense signal U_{S1} 522 may fall below a first threshold to enable the fault detection circuit 220. It should be appreciated that the first sense signal U_{S1} 522 may be representative of one or more of the terminals of the socket 514. Once enabled, the fault detection circuit 520 detects a fault when the second sense signal U_{S2} 524 is greater than a second threshold. When the second sense signal U_{S2} 524 is representative of the output current I_{O} 566, a fault is detected when the sensed output current I_{O} 566 is greater than the second threshold. In another example, when the second sense signal U_{S2} 524 is representative of the switching frequency, a fault is detected when the sensed switching frequency is greater than the second threshold. In one example, the controller 560 is disabled and prevented from switching the switch S1 548 when the fault signal U_{FAULT} 526 indicates that a fault is detected. Either the primary controller 588 or the secondary controller 589 may disable the power converter when a fault is detected. In another example, the fault signal U_{FAULT} 526 disables the power converter and prevents the switch S1 248 from switching when a fault is detected. By sensing a fault and disabling the switch S1 548, damage due to a fault such as a soft-short may be prevented.

FIG. 5B is a diagram illustrating another example switched mode power converter utilized in an example of a charging device 501 in accordance with teachings of the present invention. In particular, as shown in the depicted example, charging device 501 includes a power converter, socket 514, fault detection circuit 520, first sense signal U_{S1} 522, second sense signal U_{S2} 524, and fault signal U_{FAULT} 526. It is appreciated that the charging device 501 may be an example of charging device 104 illustrated in FIG. 1. The power converter further includes a rectifier input return 539, clamp circuit 540, energy transfer element T1 542, primary winding 544 of the energy transfer element T1 542, secondary winding 546 of the energy transfer element T1 542, power switch S1 548, output capacitor C1 550, an output rectifier 552, output return 553, resistance R_{FR} 556, capacitance CFR 558, resistance R_{DAT} 559 (optional), controller 560, an optocoupler 591 and 592, a third winding 592 of the energy transfer element 542, a diode D2 594, a resistance R2 595, and a capacitance C_{BP} 596. The socket 514 includes the output terminal VOUT 528, data terminal D+ 530, data terminal D− 532, and return terminal RTN 534. Further illustrated in FIG. 5B are the input voltage V_{IN} 537, output voltage V_{O} 564, output current I_{O} 566, drive signal 578, and a secondary drive signal 587. The controller 560 is further illustrated as including the primary controller 588 and the secondary controller 589 with a communication link 590 between the controllers 588 and 589.

The example power converter shown in FIG. 5B is similar to the power converters illustrated in FIGS. 2A and 2B, however, the output rectifier 552 is exemplified as a synchronous rectifier and the controller 560 may include the primary controller 588 and the secondary controller 589. It should also be appreciated that certain elements that were illustrated in FIGS. 2A and 2B for explanation purposes have been omitted so as not to obscure the teachings of the present invention. Similarly named and numbered elements are coupled and function as described above.

In the example depicted in FIG. 5B, fault detection circuit 522 is coupled to receive the first sense signal U_{S1} 522 from the data terminal D+ 530. In addition, the second sense signal U_{S2} 524 is coupled to be indirectly representative of the output by sensing the switching frequency of the power converter. The resistance R_{FR} 556 is coupled to the synchronous rectifier 552. In other words, the resistance R_{FR} 556 is coupled to the secondary controller 589. Capacitance C_{FR} 558 is coupled to the resistance R_{FR} 556 and output return 553 and provides the second sense signal U_{S2} 524.

As shown in the example of FIG. 5B, fault detection circuit 520 is further illustrated as being coupled to a light emitting diode (LED) 591 of an optocoupler. The LED 591 of the optocoupler is further coupled to output return 553. One end of the phototransistor 592 of the optocoupler is coupled to the third winding 592 while the other end of the phototransistor 592 is coupled to the capacitance CBP 596 and the controller 560. As illustrated, the resistance R₂ 592 is coupled across the phototransistor 592. Capacitance C_{BP} 596 is further coupled to input return 539 and the diode D2 594.

In operation, the first sense signal U_{S1} 522 may fall below a first threshold to enable the fault detection circuit 520. Once a powered device is disconnected from the power converter, the voltage on data terminal D+ 530 may be pulled low by the resistor R_{DAT} 559. The voltage on the data terminal D+ 530 (provided by the first sense signal U_{S1} 522) may fall below the first threshold and enable the fault detection circuit 520. The resistance R_{FR} 556 and capacitance C_{FR} 558 filter the secondary drive signal 587. The secondary drive signal 587 has substantially the same switching period/frequency as the drive signal 587. As such, the second sense signal U_{S2} 524 may be representative of the switching frequency of the power converter. Once the fault detection circuit 520 is enabled, a fault is detected when the second sense signal U_{S2} 524 is greater than a second threshold. In other words, a fault is detected when the sensed switching frequency is greater than the second threshold. Fault detection circuit 520 outputs the fault signal U_{FAULT} 526 when a fault is detected. In another example, second sense signal U_{S2} 524 could be received by the fault detection circuit 520 from a direct connection to the output winding 546 of the energy transfer element T1 542 (without components C_{FR} 558 and R_{FR} 556). In this example, the fault detection circuit 520 could derive information regarding the output loading of power converter through the frequency of the second sense signal U_{S2} 524 which could be decoded by the fault detection circuit 520.

In the depicted example, the fault signal U_{FAULT} 526 is coupled to be received by the LED 591 of the optocoupler. The LED 591 of the optocoupler converts the fault signal U_{FAULT} 526 into light, which is received by the phototransistor 592 of the optocoupler. Once the phototransistor 592 of the optocoupler receives the fault signal U_{FAULT} 526, the phototransistor 592 conducts and shorts the resistance R2 595. As a result, current from the third winding 593 is received by the controller 560 at the fault terminal FLT as shown in the example depicted in FIG. 5B. In the example, the received current disables the controller 560 and prevents switching of the power switch S1 548 in accordance with the teachings of the present invention.

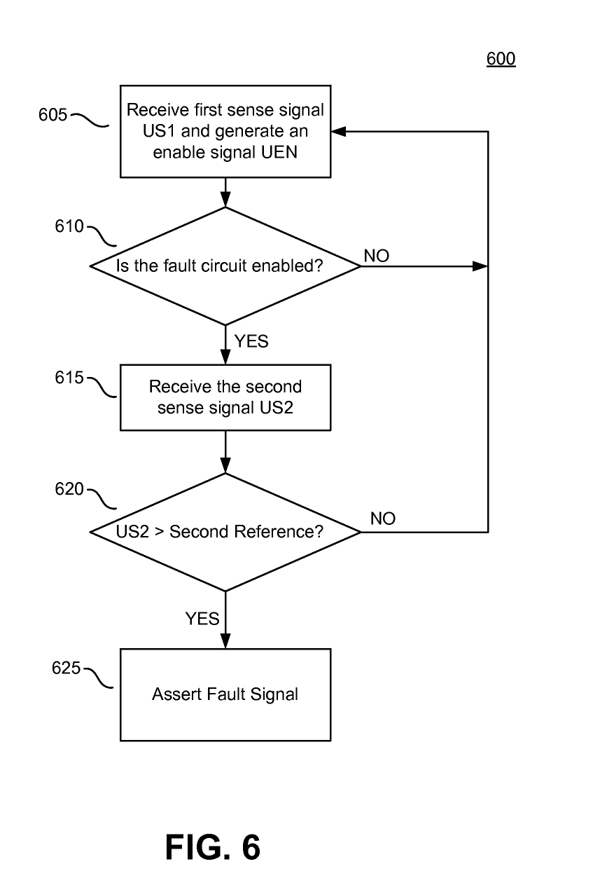

FIG. 6 is a flowchart 600 illustrating an example process of detecting an output fault in accordance with teachings of the present invention. The order in which some or all of the process blocks appear in process 600 should not be deemed as limiting. Rather, one of ordinary skill in the art having the benefit of the present disclosure will understand that some of the process blocks may be executed in a variety of orders not illustrated, or even in parallel.

In process block 605, the first sense signal US1 is received and an enable signal UEN is generated in response to the first sense signal. At block 610, it is determined if the fault circuit is enabled from the enable signal UEN. If the fault circuit is not enabled, the process returns to block 605. If the fault circuit is enabled, the process continues to block 615.

In block 615, the second sense signal US2 is received. At block 620, the second sense signal US2 is compared with a second reference. If the second sense signal is not greater than the second reference, then the process returns to block 605. If the second sense signal US2 is greater than the second reference, then the process proceeds to block 625 and a fault signal is asserted.

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention. Indeed, it is appreciated that the specific example voltages, currents, frequencies, power range values, times, etc., are provided for explanation purposes and that other values may also be employed in other embodiments and examples in accordance with the teachings of the present invention.

What is claimed is:

1. A fault detection circuit for use with a power converter, comprising:
an initiate fault check circuit coupled to generate an enable signal in response to a first sense signal coupled to be received from an output socket;
a threshold detection circuit coupled to generate a threshold detection output signal in response to a second sense signal coupled to be received from the power converter and a second reference signal; and
a logic circuit coupled to generate a fault signal coupled to be received by the power converter in response to the threshold detection output signal and the enable signal.

2. The fault detection circuit of claim 1 wherein the initiate fault check circuit comprises a first comparator coupled to generate the enable signal in response to the first sense signal and a first reference signal.

3. The fault detection circuit of claim 1 wherein the logic circuit comprises an AND gate coupled to output the fault signal in response to the threshold detection output signal and the enable signal.

4. The fault detection circuit of claim 1 wherein the first sense signal is coupled to be received from a terminal of an output socket.

5. The fault detection circuit of claim 1, wherein the first sense signal is coupled to be received from a data terminal of an output socket.

6. The fault detection circuit of claim 1 wherein the second sense signal is representative of an output current of the power converter.

7. The fault detection circuit of claim 1 wherein the second sense signal is responsive to a switching frequency of a synchronous rectifier circuit coupled to a secondary winding of the power converter.

8. The fault detection circuit of claim 1 wherein the second sense signal is representative of a switching frequency of the power converter.

9. The fault detection circuit of claim 1 wherein the second sense signal is coupled to be received from an RC circuit coupled to a secondary winding of the power converter.

10. The fault detection circuit of claim 1, wherein the second sense signal is representative of a temperature of the output socket.

11. The fault detection circuit of claim 1, wherein the fault signal is coupled to deactivate the power converter.

12. The fault detection circuit of claim 1 wherein the fault signal is coupled to be received by a controller circuit of the power converter to indicate that a fault condition is detected.

13. The fault detection circuit of claim 1 wherein the fault signal is coupled to be received by a controller circuit of the power converter through an opto-coupler to indicate that a fault condition is detected.

14. The fault detection circuit of claim 13 wherein the opto-coupler circuit is coupled to inject a current into the controller circuit in response to the fault signal to indicate that the fault condition is detected.

15. A charging device, comprising
a power converter coupled between a power converter input and an output socket to be coupled to a powered device; and
an fault detection circuit coupled to the output socket and the power converter, the fault detection circuit including:
an initiate fault check circuit coupled to generate an enable signal in response to a first sense signal coupled to be received from the output socket;
a threshold detection circuit coupled to generate a threshold detection output signal in response to a second sense signal coupled to be received from the power converter and a second reference signal; and
a logic circuit coupled to generate a fault signal coupled to be received by the power converter in response to the threshold detection output signal and the enable signal.

16. The charging device of claim 15 wherein the power converter comprises:
an energy transfer element coupled between the power converter input and the output socket;
a power switch coupled to the energy transfer element and to the power converter input; and
a controller coupled to generate a primary drive signal to control switching of the power switch in response to a feedback signal representative of an output of the power converter coupled to the output socket, wherein the second sense signal is responsive to an output load coupled to the output socket, and wherein the power switch is coupled to be deactivated in response to fault signal.

17. The charging device of claim 16 wherein the energy transfer element includes a primary winding and a secondary winding, wherein the power switch is coupled to the primary winding and the power converter input.

18. The charging device of claim 17 wherein the charging device further comprises an RC circuit coupled to the secondary winding, wherein the initiate fault check circuit is coupled to receive the second sense signal from the RC circuit.

19. The charging device of claim 17 wherein the power converter further comprises a synchronous rectifier coupled to the secondary winding, wherein the second sense signal is responsive to a secondary drive signal coupled to control switching of the synchronous rectifier circuit.

20. The charging device of claim 17 wherein the second sense signal is representative of a switching frequency of the power converter.

21. The charging device of claim 17 wherein the second sense signal is representative of a temperature of the output socket.

22. The charging device of claim 15 wherein the controller is coupled to receive the fault signal from the fault detection circuit through an opto-coupler circuit.

23. The charging device of claim 22 wherein the opto-coupler circuit is coupled to inject current into the controller in response to the fault signal to indicate that a fault condition is detected.

24. The charging device of claim 15 wherein the initiate fault check circuit comprises a first comparator coupled to generate the enable signal in response to the first sense signal and a first reference signal.

25. The charging device of claim 15 wherein the logic circuit comprises an AND gate coupled to output the fault signal in response to the threshold detection output signal and the enable signal.

26. The charging device of claim 15 wherein the first sense signal is coupled to be received from a data terminal of the output socket of the charging device.

27. A power converter, comprising:
an energy transfer element coupled between a power converter input and an output socket;
a power switch coupled to the energy transfer element and to the power converter input;
a controller coupled to generate a primary drive signal to control switching of the power switch in response to a feedback signal representative of an output of the power converter coupled to the output socket,
a fault detection circuit coupled to the output socket, the fault detection circuit including:
an initiate fault check circuit coupled to generate an enable signal in response to a first sense signal coupled to be received from the output socket;
a threshold detection circuit coupled to generate a threshold detection output signal in response to a second sense signal responsive to an output load coupled to the output of the power converter, and a second reference signal; and
a logic circuit coupled to generate a fault signal in response to the threshold detection output signal and the enable signal, and wherein the power switch is coupled to be deactivated in response to fault signal.

28. The power converter of claim 27 wherein the energy transfer element includes a primary winding and a secondary winding, wherein the power switch is coupled to the primary winding and the power converter input.

29. The power converter of claim 28 further comprising an RC circuit coupled to the secondary winding, wherein the initiate fault check circuit is coupled to receive the second sense signal from the RC circuit.

30. The power converter of claim 28 further comprising a synchronous rectifier coupled to the secondary winding, wherein the second sense signal is responsive to a secondary drive signal coupled to control switching of the synchronous rectifier circuit.

31. The power converter of claim 28 wherein the second sense signal is representative of a switching frequency of the power converter.

32. The power converter of claim 28 wherein the second sense signal is representative of a temperature of the output socket.

33. The power converter of claim 27 wherein the controller is coupled to receive the fault signal from the fault detection circuit through an opto-coupler circuit.

34. The power converter of claim 33 wherein the opto-coupler circuit is coupled to inject current into the controller in response to the fault signal to indicate that a fault condition is detected.

35. The power converter of claim 27 wherein the initiate fault check circuit comprises a first comparator coupled to generate the enable signal in response to the first sense signal and a first reference signal.

36. The power converter of claim 27 wherein the logic circuit comprises an AND gate coupled to output the fault signal in response to the threshold detection output signal and the enable signal.

37. The power converter of claim 27 wherein the first sense signal is coupled to be received from a data terminal of the output socket.
